(19) United States
(12) Patent Application Publication
(10) Pub. No.: US 2006/0248537 A1
(43) Pub. Date: Nov. 2, 2006

(54) System and method for domain security with script objects

(75) Inventor: Bennett Marks, Carlisle, MA (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/099,809

(22) Filed: Apr. 6, 2005

(51) Int. Cl. G06F 9/46; G06F 9/44

(52) U.S. Cl. 719/316

(57) ABSTRACT

A method of providing domain security with script objects includes generating an exception when a first script object with a first owner attempts access to a second script object with a second owner, generating a dialogue to the second owner querying for the grant of access rights to the second script object, and carrying out instructions whether to grant the first script object access rights to the second script object, wherein the instructions are responsive to the generated dialogue to the second owner.

### CROSS REFERENCE TO RELATED APPLICATIONS

None.

### BACKGROUND OF THE INVENTION

1. Field of the Invention

The present invention relates generally to computer scripts and security. More specifically, the present invention relates to a system and method for domain security with script objects.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

A scripting language is a programming language that is used to manipulate, customize, and automate the facilities of an existing system. In such systems, useful functionality is already available through a user interface, and the scripting language is a mechanism for exposing that functionality to program control. In this way, the existing system is said to provide a host environment of objects and facilities, which completes the capabilities of the scripting language.

ECMAScript (European Computer Manufacturers Association script) is an object-oriented programming language for performing computations and manipulating computational objects within a host environment. It is expected that the computational environment of an ECMAScript program provides not only objects but also certain environment-specific host objects.

ECMAScript is the most common scripting languages used in conjunction with (X)HTML for the creation of web pages. One of the problems that exists when using scripting in web pages is that due to the lack of a security model, it is impossible to expose client-side data and maintain confidence that the data will remain secure.

A web browser provides an ECMAScript host environment for client-side computation including, for instance, objects that represent windows, menus, pop-ups, dialog boxes, text areas, anchors, frames, history, cookies, and input/output. Further, the host environment provides a means to attach scripting code to events such as change of focus, page and image loading, unloading, error and abort, selection, form submission, and mouse actions. Scripting code appears within the (X)HTML and the displayed page is a combination of user interface elements and fixed and computed text and images. The scripting code is reactive to user interaction and there is no need for a main program. A web server provides a different host environment for server-side computation including objects representing requests, clients, and files; and mechanisms to lock and share data. By using browser-side and server-side scripting together, it is possible to distribute computation between the client and server while providing a customized user interface for a Web-based application. Each Web browser and server that supports ECMAScript supplies its own host environment, completing the ECMAScript execution environment.

The promotion of the browsing environment to a full fledged web applications environment requires that a number of facilities be added to the existing system. These include, for example, a web-aware security sub-system, access to device persistent storage, access to built-in device services, asynchronous interface(s) with network resources, a network eventing model, local and remote dynamic data binding (e.g., Xforms, Web Services, DB access), and packaging and transport agreements for moving applications around. Such facilities should be added in a manner consistent with the existing language environment (for example, XHTML+CSS+ECMAScript) to minimize learning curve and to maintain interoperability.

Heretofore, there has not been a universal access control mechanism that could be applied to ECMAScript objects. There is a need for an ECMAScript script interface to some device resources, along with a security model supporting that access. Further, there is a need for a web-aware security sub-system, access to device persistent storage, and access to built-in device services while adding the capabilities in a manner consistent with development of the technology. Even further still, there is a need for a system and method for domain security with ECMA script objects.

### SUMMARY OF THE INVENTION

In general, exemplary embodiments described herein utilize domain-based limited access and the notion of ownership and ACLs (access control lists) in such a way that the client-side end user can control access to critical client device data resources by network users. The security model described can be implemented as an extension to the ECMAScript scripting language. The implementation can be an exception driven ECMA host object. All objects that derive from this object inherit the security model. Exception driven refers to the condition that whenever there is an access to an object which is not allowed by the access control or whose policy is indeterminate at the time of access, an ECMA exception is generated.

One exemplary embodiment relates to a method of providing domain security with script objects. The method can include generating an exception when a first script object with a first owner attempts access to a second script object with a second owner, generating a dialogue to the second owner querying for the grant of access rights to the second script object, and carrying out instructions whether to grant the first script object access rights to the second script object, wherein the instructions are responsive to the generated dialogue to the second owner. In the method, there may not be an explicit owner of an object. In such case, the implied owner is the domain from whence the script originated.

Another exemplary embodiment relates to a device having domain security with script objects. The device can include a memory storing script objects and a processor that generates an exception when there is an attempt to access a script object with a script owner in the stored script objects by a second script object having a different owner than the script owner. Upon generation of the exception, the processor executes an exception code to query the script owner for access permission to the script object.

Another exemplary embodiment relates to a computer program product including computer code that generates an exception when a first script object with a first owner attempts access to a second script object with a second owner, computer code that requests access to the second script object from the second owner, and computer code that carries out instructions whether to grant the first script object access rights to the second script object where the instructions are responsive to the access request.

### BRIEF DESCRIPTION OF DRAWINGS

FIG. 1 is a general diagram of a domain-based limited access system in accordance with an exemplary embodiment.

FIG. 2 is a diagram depicting exemplary operations performed in the domain-based limited access system of FIG. 1 in accordance with an exemplary embodiment.

FIG. 3 is a diagram depicting containment hierarchy of an ECMAScript object from the system of FIG. 1 in accordance with an exemplary embodiment.

FIG. 4 is a diagram depicting class hierarchy of an ECMAScript object from the system of FIG. 1 in accordance with an exemplary embodiment.

### DETAILED DESCRIPTION OF EXEMPLARY EMBODIMENTS

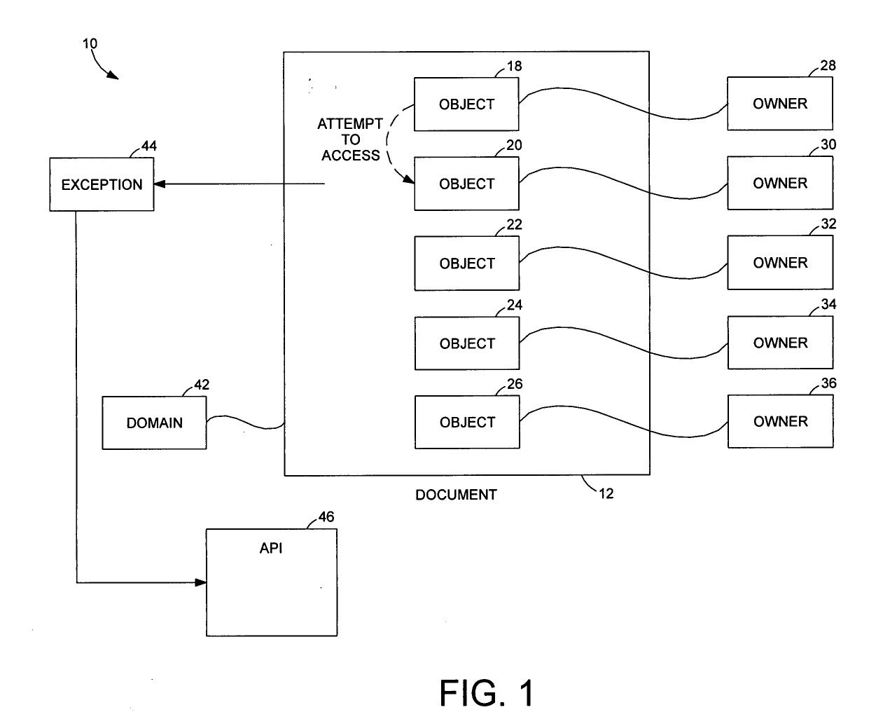

FIG. 1 illustrates a domain-based limited access system 10. In an exemplary embodiment, the domain-based limited access system 10 has a security model utilizing ECMA (European Computer Manufacturers Association) Script scripting language. The system 10 utilizes exception-driven ECMA host objects. Exception driven is understood to refer to whenever there is an attempt to access to an object which is not allowed by the access control, an ECMA exception is generated.

In the domain-based limited access system 10, a document 12 includes objects 18, 20, 22, 24, and 26. Objects 18, 20, 22, 24, and 26 are ECMA objects. Alternatively, additional, fewer, or different objects may be present in the document 12. Each of the objects 18, 20, 22, 24, and 26 has an owner. For illustration purposes, objects 18, 20, 22, 24, and 26 have owners 28, 30, 32, 34, and 36, respectively. The owner of the document 12 is a domain 42 that issued the document 12. The owner of any object which represents a local resource (e.g., a client database or file) is a “local” user.

According to exemplary embodiments, any time an object with one owner attempts to read or write to/from an object with a different owner, an exception is generated. For example, object 18 with owner 28 attempts to access object 20 with owner 30. The access attempt by object 18 can be to read from object 20 or write to object 20, for example. An exception 44 is generated if object 18 does not have access rights to object 20. The granting of read or write access to the “excepted” object is implemented by a trusted API (application programming interface) 46 that is external to the ECMAScript in the document 12. In at least one embodiment, the API 46 is implemented by a processor executing instructions to carry out operations triggered by the exception 44.

The owner of the “excepted” object may grant read access one time, read access for the session where session is defined as up until the user navigates away from the domain, read access forever, write access one time, write access for the session where session is defined as up until the user navigates away from the domain, and write access forever. In the situation where object 18 is attempting a read or write to object 20, object 20 is the excepted object and the owner 30 may grant access.

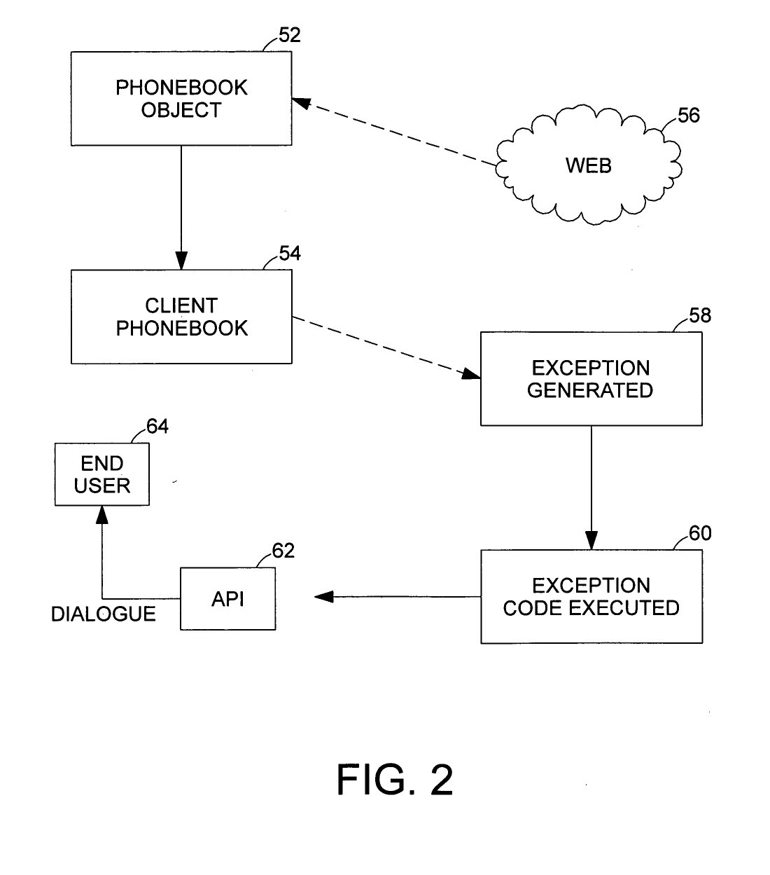

FIG. 2 illustrates an example of operations performed in the domain-based limited access system 10. Additional, fewer, or different operations may be performed depending on the embodiment or implementation. A phonebook ECMAScript object 52 provides object access to a client phonebook 54. A web page at “www.updatemypbook.com” communicates over the Internet 56 in an attempt to access or add to the client phonebook 54. In this example situation, the client phonebook 54 is owned by the “local” user. The web page (document) and the included script code are owned by the domain “updatemypbook.com”. An exception 58 is generated by the system when the script attempts to add an entry to the client phonebook 54. An exception code 60 is executed using a processor. The exception code 60 contains a call to a security API 62 which in turn generates a dialogue directly to an end-user 64 of the client phonebook 54, querying for the grant of access rights. The end-user 64 grants (or doesn't grant) access to the client phonebook 54, and a new phonebook entry is added (or not added) to the client phonebook 54.

The domain-based limited access system 10 provides a universal access control mechanism that can be applied to any applicable ECMAScript objects. Furthermore, by implementing the domain-based limited access system 10 as an exception mechanism, there is minimal impact to the scripting language and it is backwards compatible to systems which have no security model available. The domain-based limited access system 10 can be implemented not only with client-side databases such as a phonebook or calendar but also can be used as an access model for any file accessible through ECMAScript. As such, the domain-based limited access system 10 can be used as a security model for the ECMAScript Persistent Storage (PSTOR) and browsing as an applications environment.

Advantageously, the domain-based limited access system 10 provides API access to client resources. The domain-based limited access system 10 also allows for a number of use cases relevant to service providers, that cannot be accomplished using only web browsing and conventional systems.

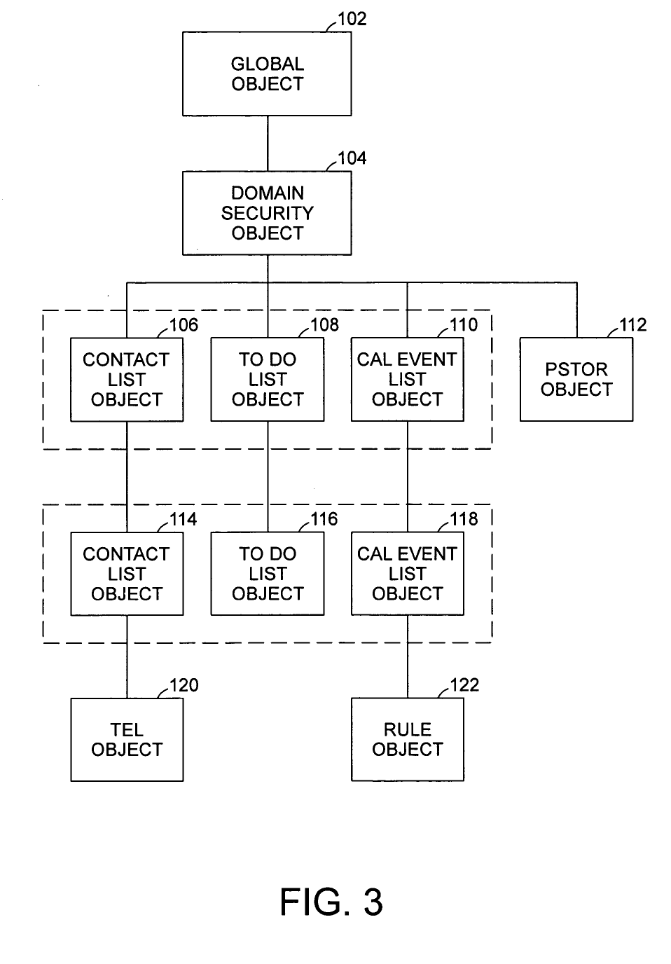

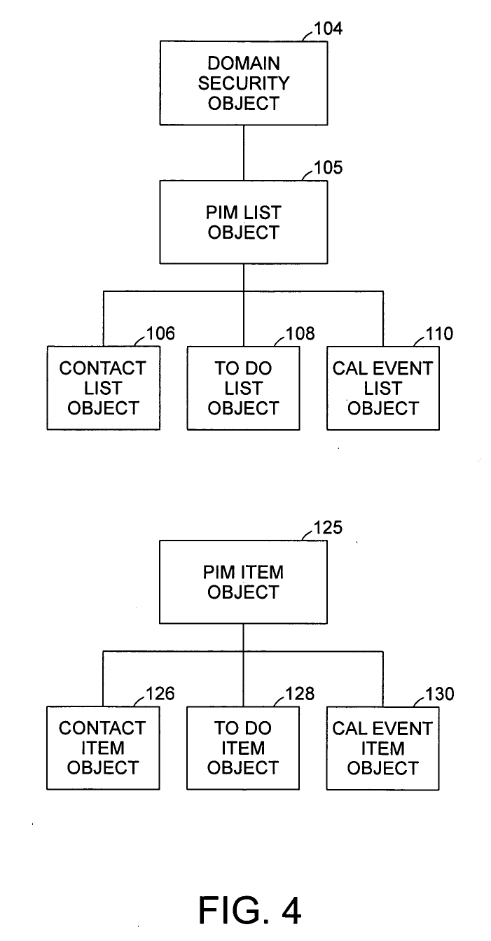

FIG. 3 illustrates a containment hierarchy of an exemplary ECMAScript object from the domain-based limited access system 10 of FIG. 1. FIG. 4 illustrates a class hierarchy of an exemplary ECMAScript object from the domain-based limited access system 10 of FIG. 1. These hierarchies correspond to a PIM (personal information manager) implementation.

Global object 102 corresponds to the EMCAScript root window. All objects descend from the window object. The properties of global object 102 include [global.]contact, [global.]todo, and [global.]calEvent. Domain security object 104 allows the end-user interface to allow or disallow interactions between the client and server. The domain security object 104 allows all descendent objects to inherit its security methods and interactions. Further, the domain security object 104 intercepts requests that cross domains, read or write. Each supported object, including contact list object 106, to do list object 108, cal event object 110, and persistent storage (PSTOR) object 112, has an owner. The contact list object 106, to do list object 108, and cal event object 110 are part of a personal information manager (PIM) system. Each supported object keeps a list of domains that are given permanent access to it. Generally, the accessing domain is the domain which issued the document.

The domain security object 104 is exception driven, such as DOMAIN_READ_EXCEPTION, DOMAIN_WRITE_EXCEPTION, and NOT_OWNER_EXCEPTION. Exceptions generally occur when there is a transfer between objects owned by different domains and access has not been granted. In the PIM implementation, for example, a document (HTML+ECMAScript) is owned by the document's source domain, the persistent store is owned by the “local” domain, PIM databases are owned by the “local” domain.

As explained previously, the owner of an object can grant read access per instance or write access per instance. Access can be granted for the current document instance or permanently. A current document instance ends as soon as there is a navigation away from the current document. [00029] By way of an illustrative example, persistent storage can be structured as a domain security object array. Each file or object within the persistent storage maintains an owner and a set of access control lists. Unlike objects within a PIM, such as contact list object 106, to do list object 108, cal event object 110, objects in the persistent storage may be restricted in what other objects in the persistent storage that are accessible. Some objects may be visible or accessible only to the owner, other objects may have visibility and read address granted automatically to the domain which was the owner of the script that first created the object. Alternatively, objects may be visible to the ECMAScript (browser) execution environment (any domain). Yet another implementation may have the objects visible to ECMAScript and other execution environments (e.g., Java).

While several embodiments of the invention have been described, it is to be understood that modifications and changes will occur to those skilled in the art to which the invention pertains. Accordingly, the claims appended to this specification are intended to define the invention precisely.

1. A method of providing domain security with script objects, the method comprising:
generating an exception when a first script object with a first owner attempts access to a second script object with a second owner;
generating a dialogue to the second owner querying for the grant of access rights to the second script object; and
carrying out instructions whether to grant the first script object access rights to the second script object, wherein the instructions are responsive to the generated dialogue to the second owner.

2. The method of claim 1, wherein the script objects are ECMA (European Computer Manufacturers Association) script objects.

3. The method of claim 1, further comprising executing exception code including a call to an API (application programming interface) which generates the dialogue to the second owner.

4. The method of claim 1, wherein the access attempted by the first script object is a read from the second script object.

5. The method of claim 1, wherein the access attempted by the first script object is a write to the second script object.

6. The method of claim 1, wherein the second script object is a client-side database.

7. The method of claim 6, wherein the client-side database is a phonebook.

8. The method of claim 1, wherein the first script object is associated with a web page.

9. The method of claim 9, wherein the second script object is associated with persistent storage.

10. The method of claim 9, wherein the persistent storage is associated with a personal information management (PIM) system.

11. A device having domain security with script objects, the device comprising:
a memory storing script objects; and
a processor that generates an exception when there is an attempt to access a script object with a script owner in the stored script objects by a second script object having a different owner than the script owner and, upon generation of the exception, executing an exception code to query the script owner for access permission to the script object.

12. The device of claim 11, wherein the exception code calls a security application programming interface (API) which generates a dialogue to the script owner, querying for the grant of access rights.

13. The device of claim 12, wherein the API is external to the stored script objects.

14. The device of claim 11, wherein access is one time, for a session, or permanent.

15. The device of claim 11, wherein the script object is a phonebook and the device comprises a mobile phone.

16. A computer program product comprising:
computer code that generates an exception when a first script object with a first owner attempts access to a second script object with a second owner;
computer code that requests access to the second script object from the second owner; and
computer code that carries out instructions whether to grant the first script object access rights to the second script object, wherein the instructions are responsive to the access request.

17. The computer program product of claim 16, wherein the computer code that requests access provides a dialogue to the second owner.

18. The computer program product of claim 16, wherein the first script object and the second script objects are Java script objects.

19. The computer program product of claim 16, wherein the instructions that carry out granting access rights trigger an application programming interface to grant read or write access.

20. The computer program product of claim 16, wherein access rights comprises any one of read access one time, read access for a session, read access permanently, write access one time, write access for a session, and write access permanently.
